(19) United States
(12) Patent Application Publication
(10) Pub. No.: US 2024/0149618 A1
(43) Pub. Date: May 9, 2024

(54) ROLLING DEVICE WITH RELEASE MECHANISM

(71) Applicant: WHEEL.ME AS, Oslo (NO)

(72) Inventors: Andreas BLOM-BAKKE, Asker (NO); Rolf LIBAKKEN, Holter (NO)

(21) Appl. No.: 18/281,623

(22) PCT Filed: Mar. 14, 2022
(86) PCT No.: PCT/EP2022/056504

§ 371 Date: Sep. 12, 2023

(30) Foreign Application Priority Data
Mar. 22, 2021 (NO) 20210365

(51) Int. Cl. B60B 33/00; B60B 19/00; B60B 33/04

(52) U.S. Cl. CPC B60B 33/001; B60B 19/003; B60B 33/0063; B60B 33/045

(57) ABSTRACT

The invention concerns a rolling device for a device to enable moving the device along a surface. The rolling device comprises a housing arranged for attachment to the device and a wheel support assembly arranged in the housing for carrying a wheel. The wheel support assembly comprises a wheel carrying member arranged for connection with the wheel, and a retainer element arranged for connection with the housing. The wheel carrying member comprises a deflective rib with an protrusion for releasable engagement with a groove of the retainer element to select the release or attachment between the wheel carrying member and the retainer element.

### TECHNICAL FIELD

The present invention concerns a rolling device for mounting or integration into a device for enabling the movement of the device along a surface. The rolling device may be remotely controlled and may be arranged for automatically moving a group of devices according to pre-set scenarios.

The invention is suitable for moving all kind of devices that is to be moved between different locations both indoors and outdoors, where the movement is to occur along a surface, for instance a floor, the ground or any other surface suitable for outdoor use.

### BACKGROUND

There are a number of circumstances where there is a need for moving various devices, for instance furniture, that may be provided with wheels or roller elements for facilitating the movement of devices from one location to another, for instance for regrouping devices or moving a device to get access to the space the device occupies or to provide access to the device itself.

The applicant has previously developed a rolling device capable of being integrated in devices, such as a piece of furniture, a movable wall etc., for moving the device along a surface. The rolling device facilitates the moving of an object and can be used by everyone regardless of physical condition and capacity to lift different devices in which the rolling device is integrated. This device is described in Norwegian Patent NO 316760 B 1.

The rolling device of NO 316760 B 1 comprises a cylindrical sleeve device for mounting in, for example, the leg of a piece of furniture, and a piston that is movably arranged in the cylindrical sleeve device. A ball-shaped or spherical wheel is arranged in the piston. The piston is movable, with the aid of a click system comprising a spring, between an upper position and a lower position. When the piston is in the lower position, the piece of furniture can be rolled across the floor it is standing on, whilst when the piston is in the upper position, the wheel is inside the cylindrical sleeve device and the leg of the piece of furniture, in which the rolling device is arranged, thus stands on the floor. The piece of furniture thus stands in the desired position without rolling inadvertently across the floor when small forces are applied to the piece of furniture. The solution is completely mechanical.

The applicant has further developed the concept and provided a rolling device with an automatic actuator system for moving a piston with a rolling element between an upper and lower position. This concept is disclosed in EP 3102429. The upper position is a passive stationary position where the wheel element is retracted in the rolling device, and the lower position is an active position for moving the rolling device along a surface. The actuator can be wirelessly controlled.

In a further version as described in WO 2018138320, the applicant has evolved the concept of the rolling device further. WO 2018138320 presents a rolling device for arrangement for autonomously moving a device from a first position to a second position along a surface. The rolling device controls the movements of a rolling element according to position acquisitions and given position and movement instructions. The rolling element may have a set or fixed vertical position relative to the rolling device or may be arranged for displacement between a retracted position where the wheel element is prevented from moving along a surface and an extended position where the wheel element is prepared for movement along the surface, as described in EP 3102429 and NO 316760 B 1.

US 2005/015928 discloses an apparatus for attaching a wheeled element, such as a caster, comprises a caster bracket with means for engaging the caster plate of a caster. The caster is affixed to the caster plate and is then engaged with the caster bracket. The caster bracket is preferably flanged for slidably receiving the caster plate which is positively held in place with the aid of a flexible locking member affixed to the caster bracket. The flexible member is operatively arranged to substantially immobilize the caster plate when the member engages a surface of a slot in the caster plate. The flexible locking member further comprises a tab extension operatively arranged to allow disengagement of the caster safely by direct hand/finger engagement without requiring tools.

The rolling device as described in the publications of the applicant as described above, comprises interacting mechanical components and electrical components. When there is a need for repair or if one the components needs to be exchanged with a new or alternative one, the procedure for disengage and later engage the component in question, involves the complexity of all interacting components. Whereas most of the components of the rolling device is stationary, the rolling element is moving and is exposed to wear and thus requires replacement from time to time. Consequently, a need has evoked for facilitating the replacement of one of the components of the rolling device, such as the wheel.

The object of the present invention is therefore to provide a rolling device capable of a simple and reliable arrangement for disassembly and assembly for replacement of the wheel. It is further an object of the invention to provide a solution that minimizes the costs for replacing the wheel, and also makes it possible for the customer or user of the rolling device to replace the wheel, without the expertise of the skilled mechanic.

The object of the invention is achieved by means of the features of the patent claims.

### SUMMARY OF THE INVENTION

The present invention relates a rolling device for a device to enable moving the device along a surface. The rolling device may typically be configured for engagement with a device such as piece of furniture, a frame arrangement carrying an object or other devices where the moving is facilitated by the use of one or more rolling devices. The rolling device may be mounted to the device in various ways; by integration of the rolling device into the device to be moved (for instance a part of the furniture), by mounting the rolling device directly or indirectly to the device to be moved by fixation means.

During ordinary use, such as in an operative mode, the wheel may have a set or fixed vertical position relative to the rolling device or may be arranged for displacement between a retracted position where the wheel is prevented from moving along a surface and an extended position where the wheel element is prepared for movement along the surface.

The rolling device comprises a housing arranged for attachment to the device. The rolling device further comprises a wheel support assembly arranged in the housing for carrying a wheel. The wheel support assembly comprises a wheel carrying member arranged for connection with the wheel and a retainer element arranged for connection with the housing. The wheel carrying member comprises a deflective rib with a protrusion for releasable engagement with a groove of the retainer element to select the release of the wheel carrying member from the retainer element or the attachment between the wheel carrying member and the retainer element.

By the arrangement of the rolling device in accordance with the invention, the wheel support assembly carrying the wheel may easily be released from the housing by applying a release force as for instance by a handgrip pulling force from a user. Two wheel support assemblies may typically be arranged at each side of the wheel.

One example of a wheel for use with the rolling device is a mecanum wheel. The mecanum wheel has a configuration allowing movement in any direction, and it is a conventional wheel with a series of rollers attached to its circumference. These rollers may typically each have an axis of rotation at 45° to the plane of the wheel and at 45° to a line through the centre of the roller parallel to the axis of rotation of the wheel, but may of course also be arranged with axis of rotation having other inclinations than 45°.

Another example of a wheel is an omnidirectional wheel, which has the ability to move in all directions. Similar to the mecanum wheel, the omnidirectional wheel has small discs (called rollers) around the circumference which are perpendicular to the turning direction. The effect is that the wheel can be driven with full force, but will also slide laterally with great ease. Omniwheels combined with conventional wheels provide unique performance properties.

The wheel may in some circumstance be replaced by a rolling element comprising a ball shape or a spherical shape or any other shape capable of providing a rolling movement in interaction with a surface.

When the wheel carrying member is attached to the retainer element, the deflective rib may be arranged in a neutral position. The deflective rib may be adapted to attain a deflective position for the release of the protrusion from the engagement with the groove.

The deflective rib may comprise a selected area configured for applying a guide and release force to disengage the protrusion from the groove, and as such release the wheel carrying member from the retainer element. Also, when attaching the wheel carrying member to the retainer element, a force is to be applied to the selected area in order to facilitate a smooth installation and attachment of the wheel carrying member to the retainer element. This will be described further below. The selected area may have the configuration of a hand or finger grip, for applying a force to disengage or engage the protrusion, when removing or inserting the wheel carrying member relative the retainer element. Further the wheel carrying member may also be configured with a hand grip to ensure stability during release and attachment of the wheel carrying member by the use of hand power.

When no force is applied to the selected area, the deflective rib may be oriented in a neutral position, typically when the protrusion is engaged in the recess or when the wheel carrying member is completely released and away from the retainer element. The deflective rib may attain a declined position when a force is applied to the selected area. This is typically the case when the protrusion is disengaged from the recess and the wheel carrying member is to be released from the retainer element. Also when the wheel carrying member is to be attached to the retainer element, the deflective rib may attain a declined position to avoid obstruction between the wheel carrying member and the retainer element during an insert procedure.

The retainer element is arranged for connection with the housing, by a direct or indirect arrangement. The retainer element may have an attachment to the inner wall of the housing or in a construction component installed in the housing. The retainer element may be positioned in the interior of the housing by a retainer holding structure.

In one aspect the housing may comprise a lifting arm arranged for displacement of the wheel into and out from the housing. The lifting arm may be arranged with a connection to the housing. The connection may typically comprise a pivot connection enabling lifting and lowering the lifting arm and thereby the wheel between a position where the wheel is retracted into the housing and a position where the wheel projects from the housing.

The lifting arm may comprise the retainer holding structure for accommodation of the retainer element. By the arrangement of the lifting arm it is possible to move the wheel support assembly carrying the wheel out from the interior of the housing, either entirely or so that some portions of the wheel support assembly projects outside the housing, when releasing the wheel carrying member from the retainer element. This outside position of the wheel support assembly may of course also facilitate the attachment of the wheel carrying member to the retainer element.

The retainer element may be movably accommodated in the retainer holding structure and comprises springs for enabling the displacement of the retainer element in the retainer holding structure in accordance with impacts from the wheel moving on the surface. When the wheel runs on a bumpy surface this will cause the compression of the springs upon hitting a bump, and thereafter the release of the spring when passing the bump.

The wheel carrying member may comprise a wheel attachment structure for connecting the wheel, the wheel attachment structure may be arranged with screw holes for fastening screws, bolts to attach the wheel to the attachment structure.

The wheel carrying member may also comprise a protruding elongated structure, which may be mounted onto the wheel attachment structure. The protruding elongated structure may comprise the deflective rib with the protrusion, and the protruding elongated structure may be adapted to fit into a recess of the retainer element to position the protrusion for releasable engagement with the groove of the retainer element. The recess of the retainer element may then function as a guide for positioning the protrusion aligned to engage with the groove of the retainer element.

The protruding elongated structure may comprise a rib recess with a depth arranged for accommodating the deflective rib and the protrusion, when the deflective rib is oriented in the deflective position. This arrangement facilitates the insert and the removal of the wheel carrying member, as the deflective position ensures that the protrusion is hidden in the recess and then the insert and removal can occur without obstruction.

The wheel support assembly may be arranged as a module unit such as a cassette to be inserted into and removed from the housing.

The housing may further be arranged for accommodation of a control and communication module comprising; a wireless receiver connected to a control device, position means connected to the control device for acquiring the position of rolling device relative to its surroundings. The rolling device may further also comprise driving means connected to the control device and the wheel for driving and controlling the movements of the wheel according to the first position acquired by the position means, and a received wireless signal comprising movement instructions and the second position. Further the rolling device may comprise power supply means for powering the control and communication module and the driving means.

The housing may also comprise an electrical interface adapted for establishing connection between the wheel and at least one of the control and communication module and the power supply means

The electrical interface may comprise a wired interface or wireless interface for communication to and from the wheel.

The driving means may typically be arranged in the interior of the wheel but may also be located elsewhere in the rolling device. A gear mechanism may also be arranged in the in the interior of the wheel, and the wheel may for instance be provided as a hub wheel.

The rolling arrangement according to the invention can be integrated in a device when the device is produced, or it may be retrofitted in a device not initially intended to be movable.

These and other characteristics of the invention will be clear from the following description of an exemplary embodiment, given as a non-restrictive example, with reference to the attached drawings.

### BRIEF DESCRIPTION OF THE DRAWINGS

In the following, embodiments of the present invention will be described in detail with reference to the enclosed drawings, where:

FIGS. 1a-1c shows schematic illustrations of the rolling device.

FIGS. 2 and 3 are two schematic side views of the rolling device with the wheel support assembly for release of the wheel.

FIG. 4 is an detail of the illustration of FIG. 3 where a wheel carrying member is attached to a retainer element.

FIG. 5 is a perspective view of the wheel carrying member released from the retainer element.

FIG. 6 is a perspective view of the retainer element.

FIGS. 7 and 8 illustrate the insert of the wheel carrying member into the recess of the retainer element.

FIGS. 9-11 illustrate the sequence of disengaging the wheel carrying member from the retainer element.

FIGS. 12-14 illustrate the sequence the disengaging the wheel from the rolling device.

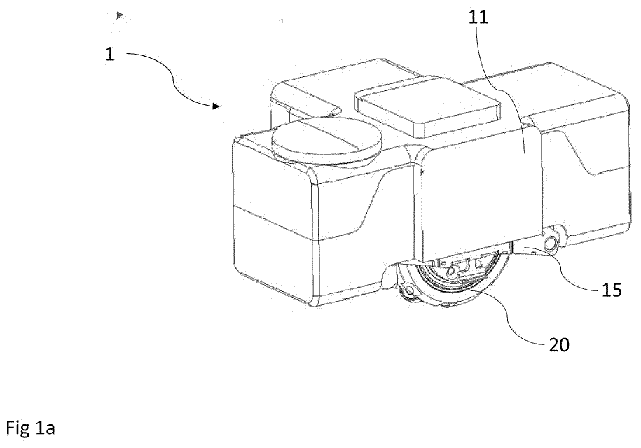

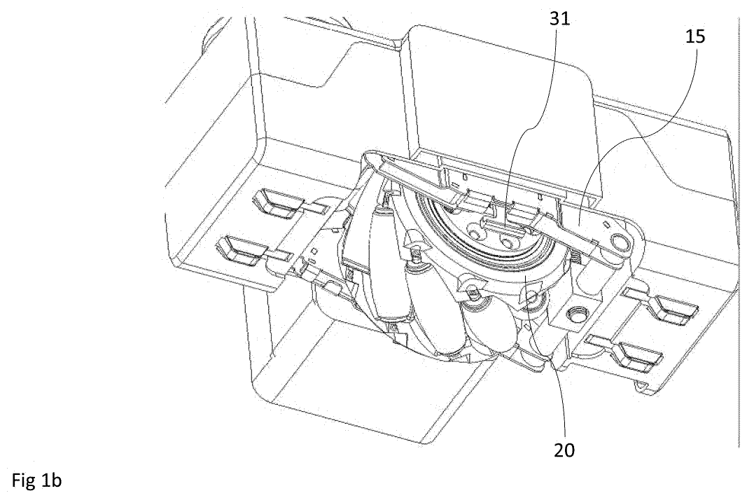

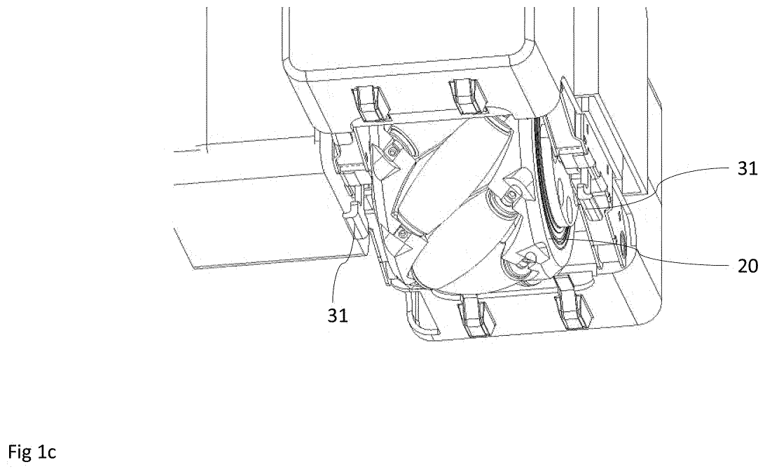

FIG. 1a show the rolling device 1 arranged with ha housing 11 where a wheel support assembly is provided for carrying a wheel 20. One wheel support assembly is arranged at each side of the wheel 20. An arm 15 for lifting and lowering the wheel 20 is illustrated. The wheel 20 as shown in this example is a Mecanum wheel.

FIGS. 1b and 1c show the rolling device 1 from below. In these figures a selected area 31 designated to be gripped by the hand or fingers of a user is visible. By applying a release force onto these selected areas 31, the wheel 20 may be released from the rolling device 1, and as such the release of the wheel 20 may be carried out by hand force of a user. This procedure as well as the specifics of the wheel support assembly will be described further below.

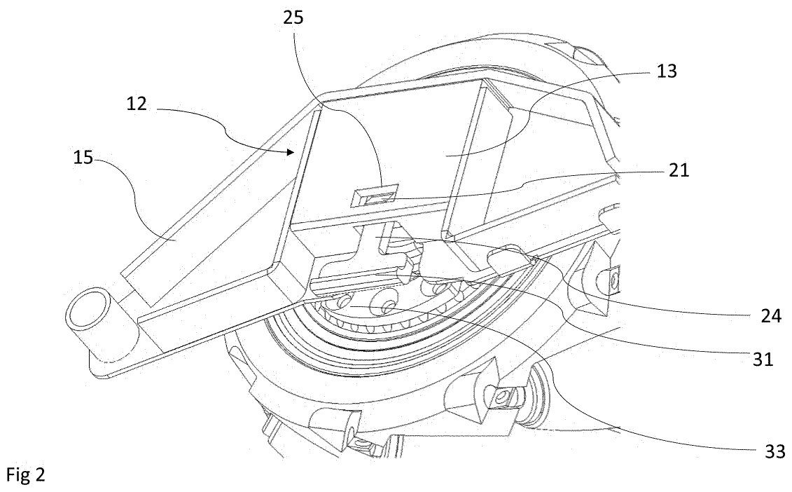

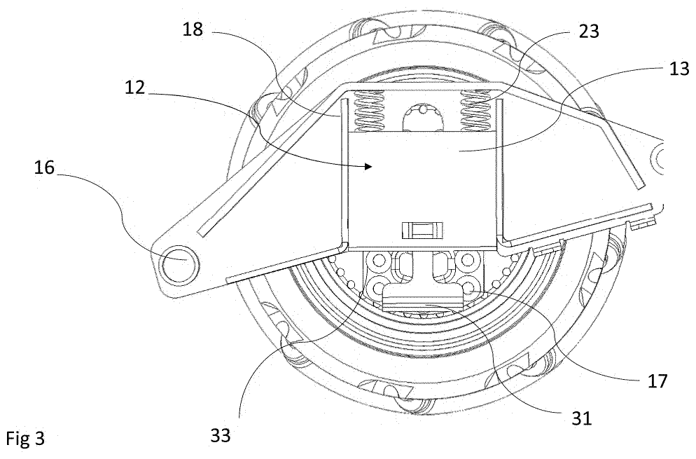

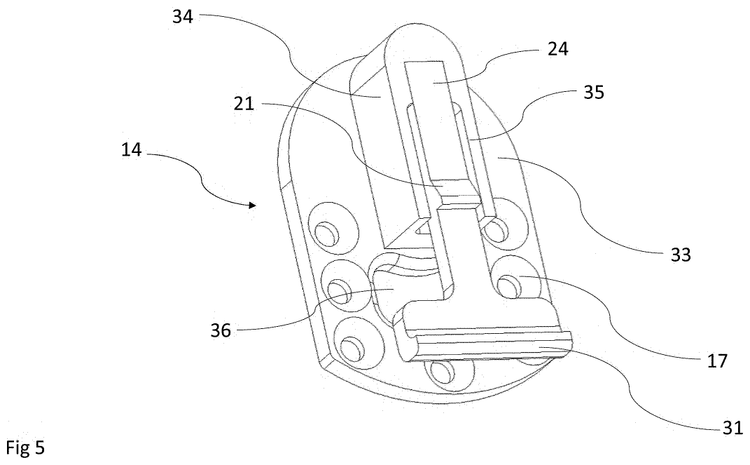

FIGS. 2 and 3 show an example of a wheel support assembly 12 as being arranged in the interior of the housing 11 (see FIG. 1a-1c). The wheel support assembly 12 comprises a wheel carrying member 14 (see FIG. 5) for attachment to the wheel 20. The wheel carrying member 14 in this example comprises a wheel attachment structure 33 connected with the wheel 20, as shown in FIGS. 2 and 3.

As explained above the wheel 20 as shown in this example comprises a Mecanum wheel and screw holes 17 as arranged in the wheel attachment structure 33 are provided for attachment to the inner stationary part of the Mecanum wheel by screws (not shown).

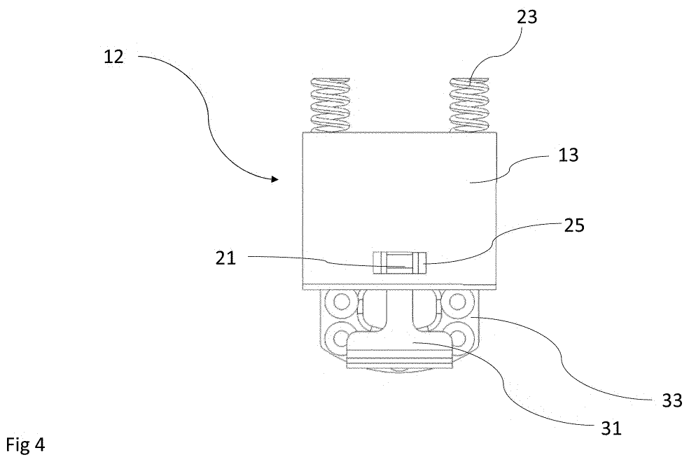

Further the wheel support assembly 12 also comprises a retainer element 13 for connection with the housing. The wheel carrying member 14 is releasably arranged in the retainer element 13, see FIGS. 4-7. The retainer element 13 is arranged for the selective release and attachment of the wheel carrying member 14 which carries the wheel 20 by connection to the wheel attachment structure 33. In accordance with one embodiment of the invention as shown in the FIG. 5, the wheel attachment member 33 comprises a deflective rib 24 arranged with a protrusion 21 for being received and releasably secured in a groove 25 formed in the retainer element 13.

The release and attachment of the protrusion 21 in the groove 25 will be described in more detail below.

In the example shown in the figs, the retainer element 13 is accommodated in a retainer holding structure 18, see FIGS. 2 and 3, arranged in a lifting arm 15. The lifting arm 15 is arranged with connection 16 to the housing. The connection may typically comprise a pivot connection enabling lifting and lowering the lifting arm and thereby the wheel 20 between a position where the wheel is retracted into the housing 11 and a position where the wheel projects from the housing 11.

In the shown example the retainer element 13 is accommodated in the retainer holding structure 18 in a manner where it is able to move, and springs 23 are provided for enabling the displacement of the retainer element 13 within the retainer holding structure 18. When the wheel carrying member 14 is attached to the retainer element as shown in FIGS. 2,3 with the protrusion 21 placed into the groove 25, the impact from the wheel 20 when for instance moving on a bumpy surface will cause the compression of the springs 23 and thereafter the release of the spring when passing the bump. The retainer element 13 is thereby caused to move up in the retainer holding structure 18 as illustrated in FIG. 2 when hitting a bump in the surface, and move down in in the retainer holding structure 18 as illustrated in FIG. 3 when having passed the bump.

FIG. 4 shows the wheel carrying member (which in this figure is illustrated by the wheel attachment structure 33) attached to the retainer element 13, similar to the situation as illustrated in FIG. 3. FIG. 5 shows the wheel carrying member 14 in a position where it is released from the retainer element 13. The wheel carrying member 14 as illustrated in FIG. 5, comprises the wheel attachment structure 33 for connecting the wheel, a protruding elongated structure 34 and the deflective rib 24 having one end portion attached to the protruding elongated structure 34 allowing the free end of the deflective rib 24 to bend or flex to move the protrusion 21 of the deflective rib into and out from engagement with the groove 25 when the wheel carrying member 14 is attached to the retainer element 13. The free end of the deflective rib 24 extends in a rib recess 35 formed in the protruding elongated structure 34.

As shown in the illustrative embodiment in the figs, the deflective rib 24 is arranged with a selected area 31 configured for applying a guide and release/insert force to disengage/engage the protrusion 21 from/with the groove 25. In the figures the selected area 31 has the configuration of a hand or finger grip, for applying a force to disengage or engage the protrusion 21 when inserting or removing the wheel carrying member 14 relative the retainer element 13. The wheel attachment structure 33 is also configured with a hand grip 36 to ensure stability when pulling the wheel carrying member 14 with the wheel 20 away from the retainer element 13, by the use of pure hand power.

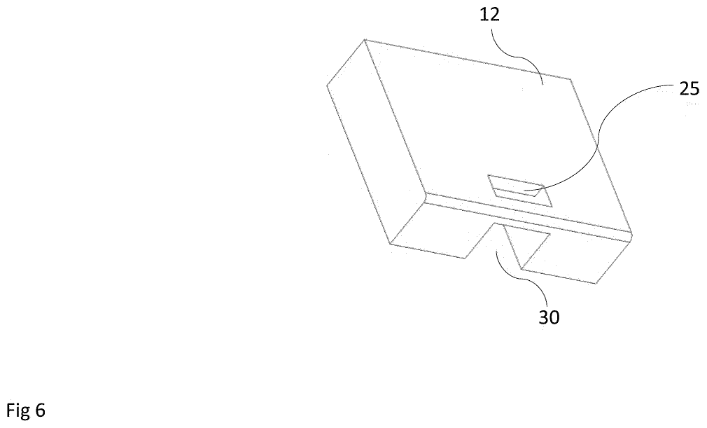

FIG. 6 shows the retainer element 13 arranged with the groove 25 for receiving the protrusion 21 of the deflective rib 24. A recess 30 is shown for receiving the protruding elongated structure 34 of the wheel carrying member 14.

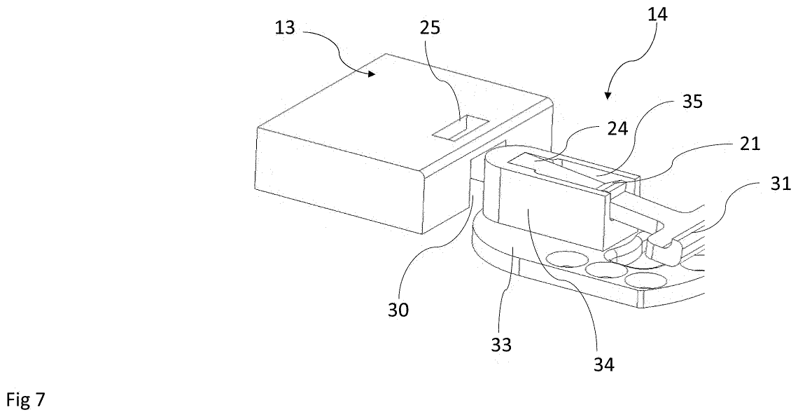

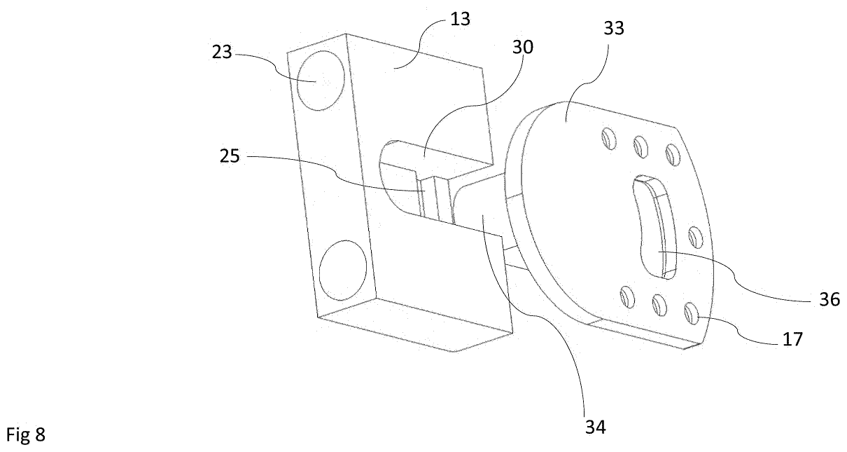

FIGS. 7 and 8 show an example of steps of releasing or inserting the wheel carrying member 14 out from or into the recess 30 of the retainer element 13. As seen in the FIGS. 7 and 8, the free end of the deflective rib 24 is moved downward in the rib recess 35, typically by the user who applies a force to the selected area 31. The height of the protruding elongated structure 34 corresponds to the depth of the recess 30 and the free end of the rib 24 is to be kept in downward position into the rib recess 35 to avoid that the protrusion 21 obstructs the release or insert of the protruding elongated structure 34 from or into the recess 30.

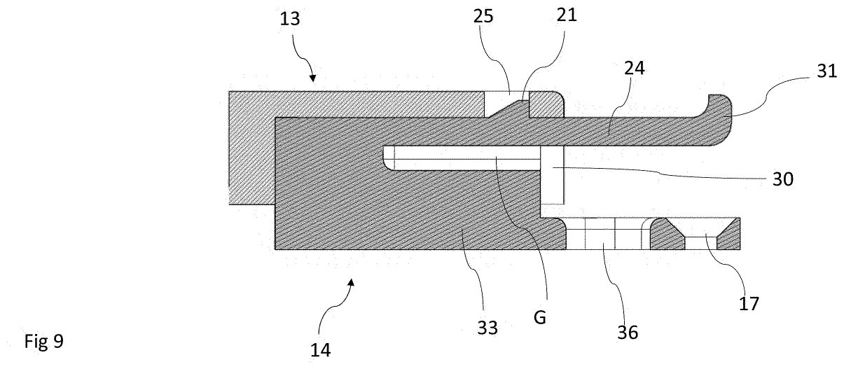

FIG. 9-11 illustrates the sequence of disengaging the wheel carrying member 14 from the retainer element 13. The reverse order of this sequence describes the engagement of the wheel carrying member 14 with the retainer element 13.

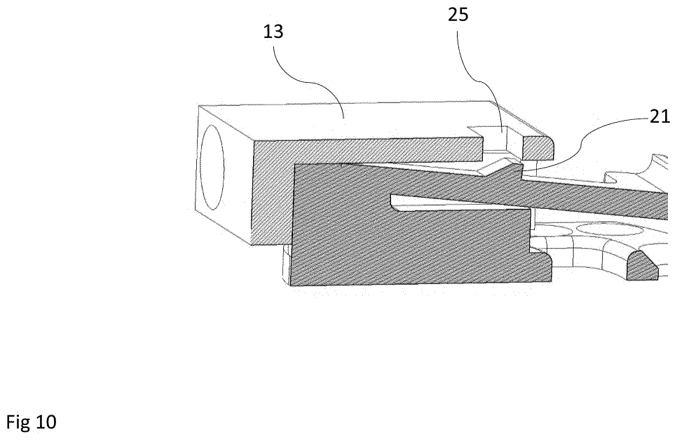

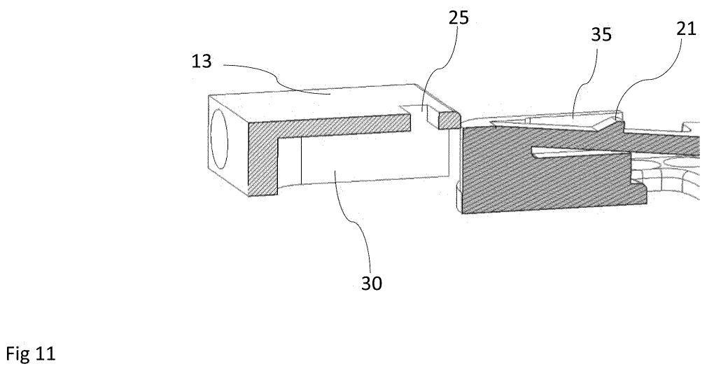

FIG. 9 shows the protruding elongated structure 34 inserted into the recess 30 of the retainer element 13. The protrusion 21 of the deflective rib 24 is engaged in the groove 25, and the wheel carrying member 14 is as such attached to the retainer element 13. For the release of the wheel carrying member 14 from the retainer element 13, a release force is to be applied to the selected area 31 for instance by hand force as conducted by a user. The free end of the deflective rib 24 then deflects and the protrusion 21 is disengaged from the groove 25 and into the rib recess 35 as shown in FIG. 10. The wheel carrying member 14 is now free to be pulled out from the recess of the retainer element 12 for instance by pulling using the selected area 31 and the holding grip 36, see FIG. 11.

When the wheel carrying member 14 is to be engaged with the retainer element 13, the sequence is reversed starting from the position shown in FIG. 11, where the rib is deflected and lowered into the rib recess 35 by applying a force onto the selected area 31. From this position the wheel carrying member 14 is inserted into the recess of the retainer element 13 as shown in FIG. 10. The force is removed from the selected area 31, for instance by releasing the hand grip. The deflective rib 24 then regains its neutral position and moves the protrusion 21 into the groove 25 as shown in FIG. 9. The wheel carrying member 14 is then engaged with the retainer element 13.

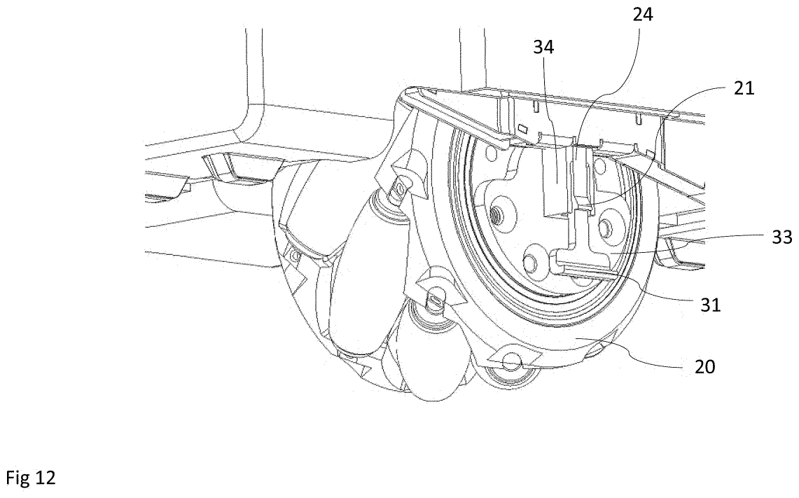

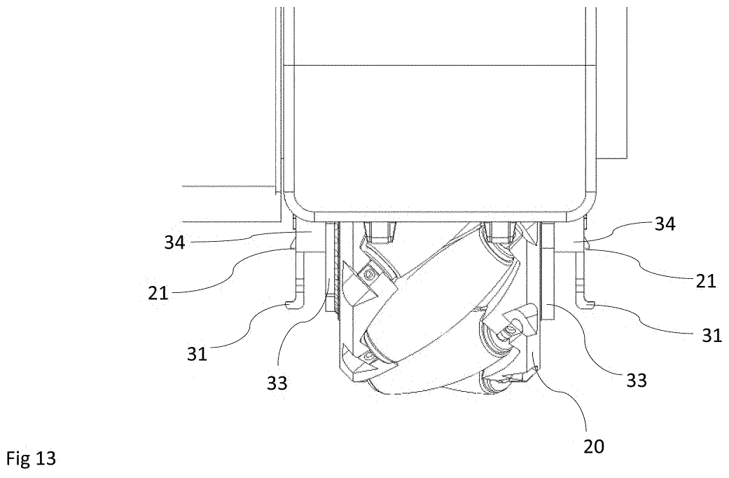

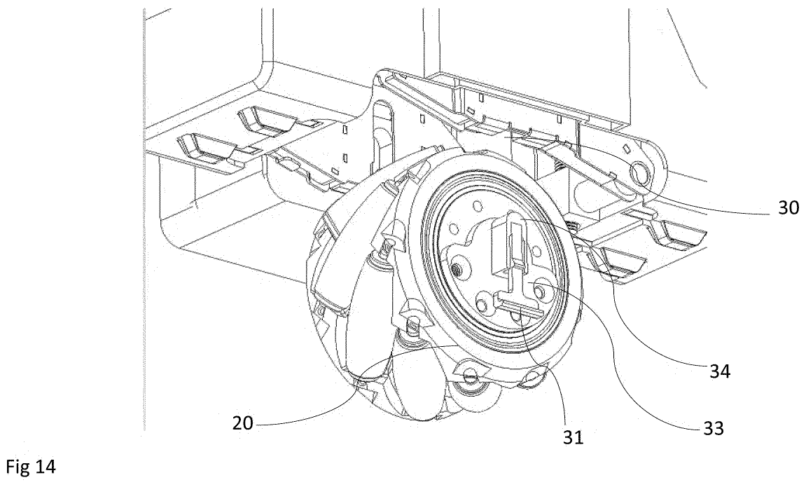

The release of the wheel 20 as attached to the wheel attachment structure 33 by the use of the sequence of FIGS. 9-11 is shown in FIGS. 12-14. FIG. 12 shows the protrusion 21 of the deflective rib 24 as released from the groove 25, this situation corresponds to that of the illustration of FIG. 11, except that the deflective rib 24 as illustrated in FIG. 12 has returned to its neutral position. FIG. 13 shows the same situation as that of FIG. 12, but in a side view. FIG. 13 shows the wheel 20 as completely released from the rolling device 1.

1. A rolling device for a device to enable moving the device along a surface wherein the rolling device comprises:
a housing arranged for attachment to the device,
a wheel support assembly arranged in the housing for carrying a wheel, wherein
the wheel support assembly comprises a wheel carrying member arranged for connection with the wheel, and a retainer element arranged for connection with the housing, wherein
the wheel carrying member comprises a deflective rib with an protrusion for releasable engagement with a groove of the retainer element to select the release or attachment between the wheel carrying member and the retainer element.

2. The rolling device according to claim 1, where the deflective rib has a neutral position when the wheel carrying member is attached to the retainer element and is adapted to attain a deflective position for the release of the protrusion from the engagement with the groove.

3. The rolling device according to claim 2, where the deflective rib comprises a selected area configured for applying a guide and release force to disengage the protrusion from the groove and release the wheel carrying member from the retainer element.

4. The rolling device according to claim 1, where the housing comprises a lifting arm for displacement of the wheel into and out from the housing, where the lifting arm comprises a retainer holding structure for accommodation of the retainer element.

5. The rolling device according to claim 4, where the retainer element is movably accommodated in the retainer holding structure and comprises springs for enabling the displacement of the retainer element in the retainer holding structure in accordance with impacts from the wheel moving on the surface.

6. The rolling device according to claim 2, where the wheel carrying member comprises
a wheel attachment structure for connecting the wheel
a protruding elongated structure comprising the deflective rib with the protrusion, wherein the protruding elongated structure is adapted to fit into a recess of the retainer element to position the protrusion for releasable engagement with the groove of the retainer element.

7. The rolling device according to claim 7, where the protruding elongated structure comprises a rib recess with a depth arranged for accommodating the deflective rib and the protrusion when the rib is oriented in the deflective position.
